(19) United States
(12) Patent Application Publication
(10) Pub. No.: US 2006/0138229 A1
(43) Pub. Date: Jun. 29, 2006

(54) Printer having RFID read/write function

(75) Inventor: Makoto Sugiyama, Mishima (JP)

Correspondence Address: HARNESS, DICKEY & PIERCE, P.L.C., P.O. BOX 828, BLOOMFIELD HILLS, MI, 48303, US

(73) Assignee: Toshiba Tec Kabushiki Kaisha

(21) Appl. No.: 11/314,463

(22) Filed: Dec. 21, 2005

(30) Foreign Application Priority Data
Dec. 27, 2004 (JP) 2004-376326

(51) Int. Cl. G06K 7/00; G06F 15/12

(52) U.S. Cl. 235/435; 235/432

(57) ABSTRACT

A printer having a feed unit to feed a label or tag containing an RFID tag, a print unit to print on the surface of the label or tag, an RFID read/write unit to read/write the RFID tag. The printer has a control unit to control the RFID read/write unit to write data to the RFID tag while the feed unit is feeding the RFID tag.

### CROSS-REFERENCE TO RELATED APPLICATIONS

This application is based upon and claims the benefit of priority from prior Japanese Patent Application No. 2004-376326, filed Dec. 27, 2004, the entire contents of which are incorporated herein by reference.

### BACKGROUND OF THE INVENTION

1. Field of the Invention

The present invention relates to a printer having an RFID read/write function with a built-in RFID read/write unit capable of reading and writing data in a noncontact manner.

2. Description of the Related Art

Generally, an RFID (Radio Frequency Identification) label or tag can be read and written in a noncontact manner by using a radio wave, and is significant as a technique substitutable for a barcode.

However, if a barcode reading system installed now in a shop is changed to an RFID applicable system, a current barcode cannot be read.

Thus, it becomes necessary to print a bar code and write data to an RFID tag. As a device to satisfy this need, a printer having the function of printing a barcode and writing data to an RFID tag has been known (Jpn. Pat. Appln. KOKAI Publication No. 2001-96814). This printer writes data on RFID by feeding a label in the label feeding direction, and prints a barcode on the surface of a label by feeding the label in the reverse direction.

For example, a label as shown in FIG. 2 is available for RFID. In FIG. 2, a reference numeral 11 denotes a liner, and 12 denotes a label. An RFID tag 13 is placed between the liner 11 and label 12. The RFID tag 13 comprises an RFID antenna 14 and an RFID chip 15.

However, as a radio technology is used for writing data in the RFID tag 13, the writing may fail. The failure is often caused by the difference between the RFID tag 13 and RFID chip 15. The difference mentioned here means the structural difference between the RFID tag 13 and RFID chip 15.

### BRIEF SUMMARY OF THE INVENTION

It is an object of the present invention is to provide a printer having an RFID read/write function capable of writing data in an RFID tag without fail.

According to one aspect of the invention, there is provided a printer comprising a feed unit configured to feed a label or tag containing an RFID tag; a print unit configured to print on the surface of the label or tag; an RFID read/write unit configured to read/write the RFID tag; and a control unit configured to control the RFID read/write unit to write data to the RFID tag while the feed unit is feeding the RFID tag.

Additional objects and advantages of the invention will be set forth in the description which follows, and in part will be obvious from the description, or may be learned by practice of the invention. The objects and advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate embodiments of the invention, and together with the general description given above and the detailed description of the embodiments given below, serve to explain the principles of the invention.

FIG. 1 is a block diagram of the configuration of a printer having an RFID read/write function according to an embodiment of the present invention;

FIG. 2 is a view showing an RFID label according to the same embodiment;

FIG. 3 is a view showing the configuration of the printer having the RFID read/write function according to the same embodiment; and

FIG. 4 is a flowchart for explaining the operation of the same embodiment.

### DETAILED DESCRIPTION OF THE INVENTION

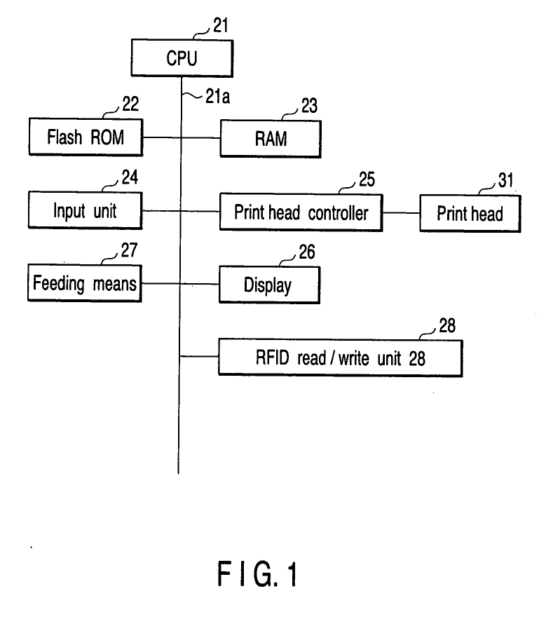

An embodiment of the present invention will be explained hereinafter with reference to the accompanying drawings. First, explanation will be give on the system configuration of a printer having the RFID read/write function with reference to the block diagram of FIG. 1.

In FIG. 1, a reference numeral 21 denotes a CPU (Central Processing Unit) to perform centralized control of the printer. A system bus 21a from the CPU 21 is connected to a flash ROM (Read Only Memory) 22, a RAM (Random Access Memory) 23, an input unit 24, a print head controller 25, a display 26, a feeding means 27, and an RFID read/write unit 28.

A print head 31 is connected to the print controller 25.

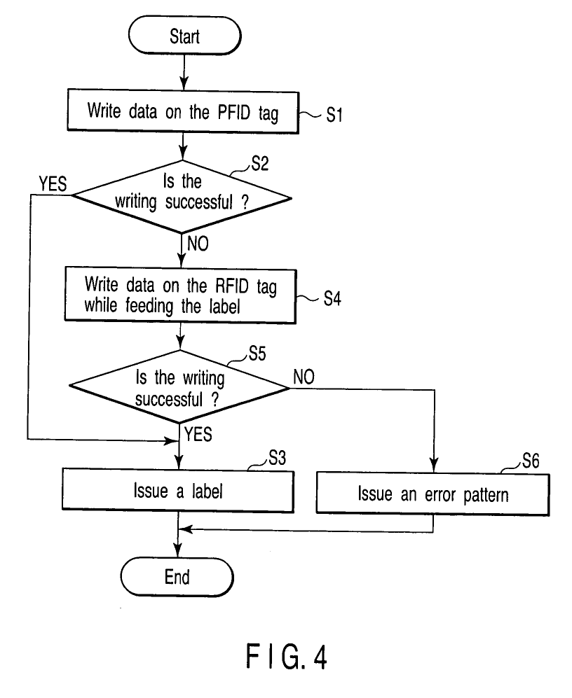

The flash ROM 22 stores various control programs necessary for the operation of the printer as shown in FIG. 4.

The RAM 23 ensures a work area used by the various control programs.

The print head controller 25 outputs a driving signal to the print head 31 composed of a thermal head, for example.

The display 26 is composed of a liquid crystal display, for example.

The feeding means 27 is composed of a stepping motor and a feeding roller, for example, which feed the liner 11.

Next, explanation will be given on the essential part of the hardware configuration of the printer having the RFID read/write function with reference to FIG. 3.

In FIG. 3, a reference numeral 41 denotes a feeding path to feed the liner 11. The liner 11 is fed on the feeding path 41 by the feeding means 27.

A reference numeral 42 denotes a platen roller. The RFID read/write unit 28 is provided on the upstream side of the platen 42.

The print head 31 is placed opposite to the platen 42 through the feeding path 41. The print head 31 is composed of a thermal head, for example.

On the upstream of the print head 31, a supply side roller 44 to supply an ink ribbon 43 is provided. On the downstream of the print head 31, a take-up side roller 45 to take up the ink ribbon 43 is provided.

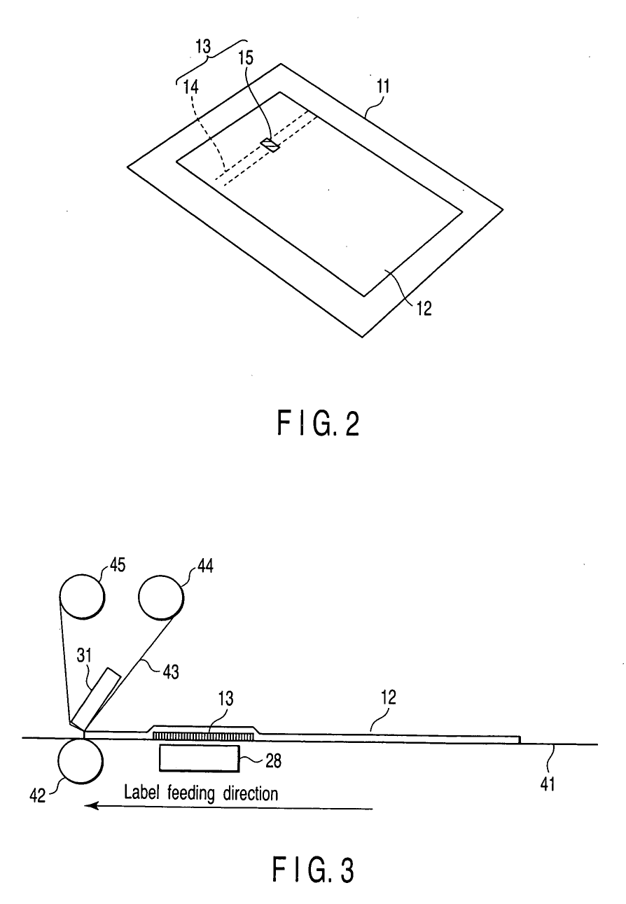

FIG. 3 shows the position of the RFID tag of FIG. 2 when the print head 31 comes to the home position. The home position is a position in which the print head 31 starts printing. In the RFID tag 13 of FIG. 2, the RFID antenna 14 and RFID chip 15 are buried close to the print head 31 in the label 12. Therefore, the RFID antenna 14 and RFID chip 15 are placed substantially above the RFID read/write unit 28.

Next, explanation will be given on the operation of an embodiment configured as above of the invention with reference to the flowchart of FIG. 4. First, when RFID data is input from a personal computer (not shown) via the input unit 24, the RFID read/write unit 28 writes RFID data on the RFID tag 13 (step S1). The RFID tag data includes merchandise data (a name, price, etc. of merchandise).

Then, the RFID read/write unit 28 judges whether the writing of data in the RFID tag 13 is completed (step S2).

When YES in the judgment of step S2, a label is issued (step S3). Namely, the print head 31 prints merchandise data such as a name and barcode of merchandise on the label 12.

If NO in step S2, the feeding means 27 starts feeding the label 12. Then the data is written on the RFID tag 13 while the feeding means 27 is feeding the label 12 (step S4). After finishing writing RFID data, the written RFID data is read and it is judged whether writing RFID data is normally performed or not. If it is judged that RFID data is normally written, the label 12 is issued.

On the other hand, if it is judged that RFID data is not normally written, writing RFID data operation is performed predetermined times. And writing RFID data to the RFID tag 13 while the feeding means 27 is performed, namely the operation is retried.

Then, whether the writing data on the RFID tag 13 is successful is judged (step S5).

When YES is judged in step S5, a label is issued as described above (step 3).

If NO in step S5, that is, writing data to the RFID tag 13 is unsuccessful even if writing operation in step S4 is performed predetermined times, an error pattern is printed on the surface of the label 12 (step S6). For example, a pattern of X is printed on the surface of the label 12 as an error pattern.

As described above, a label is moved while data is written to the RFID tag 13 in this embodiment, data can be surely written to the RFID tag 13.

Data is written to the RFID tag 13 while the RFID tag 13 is being fed in the embodiment. Data may be written on the RFID tag 13, after feeding the RFID tag 13 by the feeding means 27, for example, feeding it by one step or several steps of the stepping motor and stop reading. Of course, if data cannot be written by one retry, data may be written by several retry.

Moreover, The RFID read/write unit 28 may writes data on the RFID tag once at first time when the label is stop.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A printer comprising:
a feed unit configured to feed a label or tag containing an RFID tag;
a print unit configured to print on the surface of the label or tag;
an RFID read/write unit configured to read/write the RFID tag; and
a control unit configured to control the RFID read/write unit to write data to the RFID tag while the feed unit is feeding the RFID tag.

2. The printer according to claim 1, wherein the print unit is comprised of a thermal printer.

3. The printer according to claim 1, wherein the RFID read/write unit writes data to the RFID tag once at first time when the label is stop.

4. The printer according to claim 3, wherein the label of stopped state is on a home position.

5. The printer according to claim 4, wherein the home position is a position in which the print head 31 starts printing.

6. The printer according to claim 1, wherein data is input from a outside device.

7. The printer according to claim 1, further comprising a judgment unit configured to judge whether writing to the RFID tag is successful,
wherein the control unit controls the RFID read/write unit to write data to the RFID tag while the feed unit is feeding the RFID tag, when the judgment unit judges that writing to the RFID tag is unsuccessful.

8. The printer according to claim 7, wherein the RFID read/write unit repeat writing data several times to the RFID tag until writing operation is successful.

9. A printer comprising:
a feed unit configured to feed a label or tag containing an RFID tag;
a print unit configured to print on the surface of the label or tag;
an RFID read/write unit configured to read/write the RFID tag; and
a control unit configured to control the RFID read/write unit to write data to the RFID tag after the feed unit feeds the RFID tag by a fixed amount.

10. The printer according to claim 9, wherein the print unit is comprised of a thermal printer.

11. The printer according to claim 9, wherein the RFID read/write unit writes data to the RFID tag once at first time when the label is stop.

12. The printer according to claim 11, wherein the label of stopped state is on a home position.

13. The printer according to claim 12, wherein the home position is a position in which the print head 31 starts printing.

14. The printer according to claim 9, wherein data is input from a outside device.

15. The printer according to claim 9, further comprising a judgment unit configured to judge whether writing to the RFID tag is successful,
wherein the control unit controls the RFID read/write unit to write data to the RFID tag after the feed unit feeds the RFID tag by a fixed amount, when the judgment unit judges that writing to the RFID tag is unsuccessful.

16. The printer according to claim 15, wherein the RFID read/write unit repeat writing data several times to the RFID tag until writing operation is successful.

17. A printing method comprising:
a feeding a label or tag containing an RFID tag;
a printing on the surface of the label or tag;
reading/writing the RFID tag; and
controlling to write data to the RFID tag while feeding the RFID tag.

18. The printing method according to claim 17, further comprising a judging whether writing to the RFID tag is successful,
wherein writing data to the RFID tag while feeding the RFID tag, when it is judged that writing to the RFID tag is unsuccessful.

19. A printing method comprising:
a feeding a label or tag containing an RFID tag;
a printing on the surface of the label or tag;
reading/writing the RFID tag; and
controlling to write data to the RFID tag after the feed unit feeds the RFID tag by fixed amount.

20. The printer according to claim 19, further comprising a judging whether writing to the RFID tag is successful,
wherein controlling to write data to the RFID tag after feeding the RFID tag by fixed amount, when it is judged that writing to the RFID tag is unsuccessful.
